(19) United States
(12) Patent Application Publication
(10) Pub. No.: US 2010/0053540 A1
(43) Pub. Date: Mar. 4, 2010

(54) Laser Filtering Optical System

(75) Inventors: Jessica Blayden, Santee, CA (US); Patrick Shipley, Sun Praire, WI (US)

Correspondence Address: WOOD, HERRON & EVANS, LLP, 2700 CAREW TOWER, 441 VINE STREET, CINCINNATI, OH, 45202, US

(73) Assignee: KERR CORPORATION, Orange, CA (US)

(21) Appl. No.: 12/547,949

(22) Filed: Aug. 26, 2009

Related U.S. Application Data
(60) Provisional application No. 61/093,059, filed on Aug. 29, 2008.

(51) Int. Cl. G02C 7/10

(52) U.S. Cl. 351/44

(57) ABSTRACT

An optical loupe includes a housing, an eyepiece lens supported in the housing, and an objective lens supported in the housing. The optical loupe further includes a filter lens supported in the housing and adapted to prevent the transmission of electromagnetic radiation of at least a predetermined wavelength. In another embodiment, a user-wearable optical system includes a user-wearable device and an optical loupe having an objective lens, an eyepiece lens, and a filter lens supported in a housing. The filter lens is adapted to prevent the transmission of electromagnetic radiation of at least a predetermined wavelength.

### CROSS-REFERENCE TO RELATED APPLICATIONS

This application claims priority to U.S. Provisional Patent Application Ser. No. 61/093,059 filed on Aug. 29, 2008, the disclosure of which is incorporated by reference herein in its entirety.

### TECHNICAL FIELD

The present invention relates generally to magnifying devices, and more particularly to a magnification device configured to filter laser light or other electromagnetic radiation.

### BACKGROUND

Magnification viewers, including, but not limited to, pairs of magnification loupes, are worn by dentists and surgeons for extended periods of time during clinical procedures. These viewers are worn to provide clarity of view while avoiding a hunched-over position that can, over time, result in debilitating neck and back strain and can also have an adverse effect on the success of the procedure being performed. Magnification viewers allow a practitioner to operate at a greater working distance from a patient than without the viewers. Higher magnification viewers also reduce the practitioner's exposure to aerosols and other substances. Because practitioners use magnification viewers during surgery and the performance of other procedures requiring manual precision, it is important that the viewers be lightweight, comfortable, and provide good clarity and a wide field of vision at a high magnification and with a good depth of field.

The use of lasers has become increasingly common in the performance of dental and medical procedures. When practitioners are working with lasers during these procedures, their eyes must be protected to avoid incurring damage to their eyes. Conventional devices available for protecting a practitioner's eyes from laser light include goggles and “clip-on” type shields that may be worn over an otherwise unprotected magnification viewer. These conventional add-on devices are generally uncomfortable and/or adversely affect the clear vision of the practitioner using the magnification viewer. Accordingly, there is a need for a magnification viewer that overcomes these and other drawbacks of conventional devices for protecting a practitioner's eyes during the performance of procedures using lasers.

### SUMMARY

The present invention overcomes the foregoing and other shortcomings and drawbacks of magnification viewers heretofore known for use in performing various dental and medical procedures. While the invention will be described in connection with certain embodiments, it will be understood that the invention is not limited to these embodiments. On the contrary, the invention includes all alternatives, modifications and equivalents as may be included within the scope of the present invention.

In one aspect, an optical loupe comprises a housing supporting an eyepiece lens and an objective lens. The optical loupe further includes a filter lens supported in the housing. The filter lens is adapted to prevent the transmission of electromagnetic radiation of at least a predetermined wavelength. In one embodiment, the filter lens is adapted to prevent the transmission of laser light with wavelengths in the range of about 800 nm to about 830 nm at a power/pulse energy of up to about 10 Watts. In another embodiment, the filter lens is adapted to prevent the transmission of multi-wave laser light with wavelengths in the range of about 940 nm to about 980 nm, about 1064 nm, and about 2780 nm to about 2940 nm at a power/pulse energy of up to about 12 Watts. In yet another embodiment, the filter lens is adapted to prevent the transmission of laser light with wavelengths in the range of about 2780 nm to about 2940 nm at a power/pulse energy of up to about 12 Watts.

In another aspect, a user-wearable optical system includes a user-wearable device and an optical loupe supported on the user-wearable device. The optical loupe comprises a housing supporting an eyepiece lens and an objective lens. The optical loupe further includes a filter lens supported in the housing. The filter lens is adapted to prevent the transmission of electromagnetic radiation of at least a predetermined wavelength. In one embodiment, the user-wearable device is a pair of eyeglasses, and the optical loupe is supported by a carrier lens of the eyeglasses. In a further embodiment, the carrier lens is adapted to prevent the transmission of electromagnetic radiation of at least the predetermined wavelength.

The above and other objects and advantages of the present invention shall be made apparent from the accompanying drawings and the description thereof.

### BRIEF DESCRIPTION OF THE FIGURES

The accompanying drawings, which are incorporated in and constitute a part of this specification, illustrate exemplary embodiments of the invention and, together with a general description given above, and the detailed description given below, serve to explain the invention in sufficient detail to enable one of ordinary skill in the art to which the invention pertains to make and use the invention.

FIG. 1 is a perspective view of an exemplary optical device in accordance with the present disclosure.

FIG. 2 is a cross-sectional view of an optical loupe used with the optical device of FIG. 1.

FIG. 3 is an exploded view of the optical loupe of FIG. 2.

### DETAILED DESCRIPTION

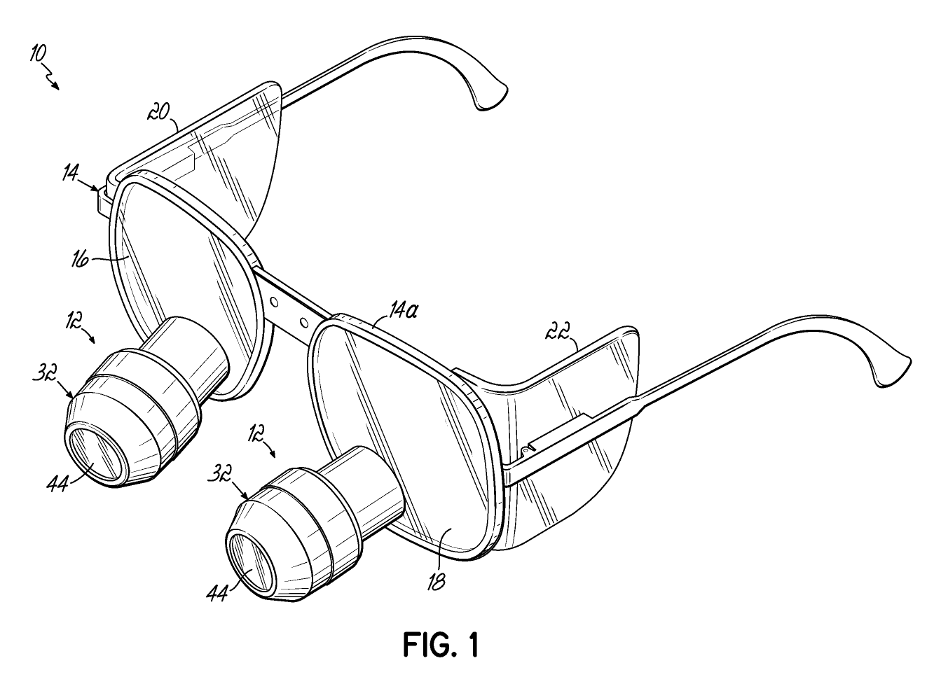

FIG. 1 depicts an exemplary user-wearable optical device 10 including exemplary optical loupes 12 in accordance with the present disclosure. In the embodiment shown, the user-wearable optical device 10 is in the form of a pair of spectacles, or eyeglasses 14, that may be worn by a medical or dental practitioner during the performance of a procedure requiring magnified vision. The eyeglasses 14 include eyeglass frames 14a supporting a pair of carrier lenses 16, 18. The carrier lenses 16, 18 may be prescription lenses or Piano lenses, and may be made from any material suitable to prevent the passage of laser light or other electromagnetic radiation of various wavelengths, while being transparent to light in the visible spectrum. The optical loupes 12 are supported by the respective carrier lenses 16, 18 and are permanently fixed to the carrier lenses 16, 18, either by being bonded to the lenses or supported through apertures formed through the carrier lenses 16, 18. The user-wearable optical device 10 may further include side shields 20, 22 provided adjacent the carrier lenses 16, 18 and being made from a material suitable to prevent at least the transmission of laser light or other electromagnetic radiation of various wavelengths. Alternatively, the side shields 20, 22 may be completely opaque.

While the user-wearable optical device 10 has been shown and described herein as a pair of eyeglasses 14, it will be appreciated that the optical device 10 may alternatively be in the form of various other structure suitable for supporting optical loupes 12 proximate the eyes of a practitioner, such as a face shield, goggles, helmet, visor, or any other suitable structure.

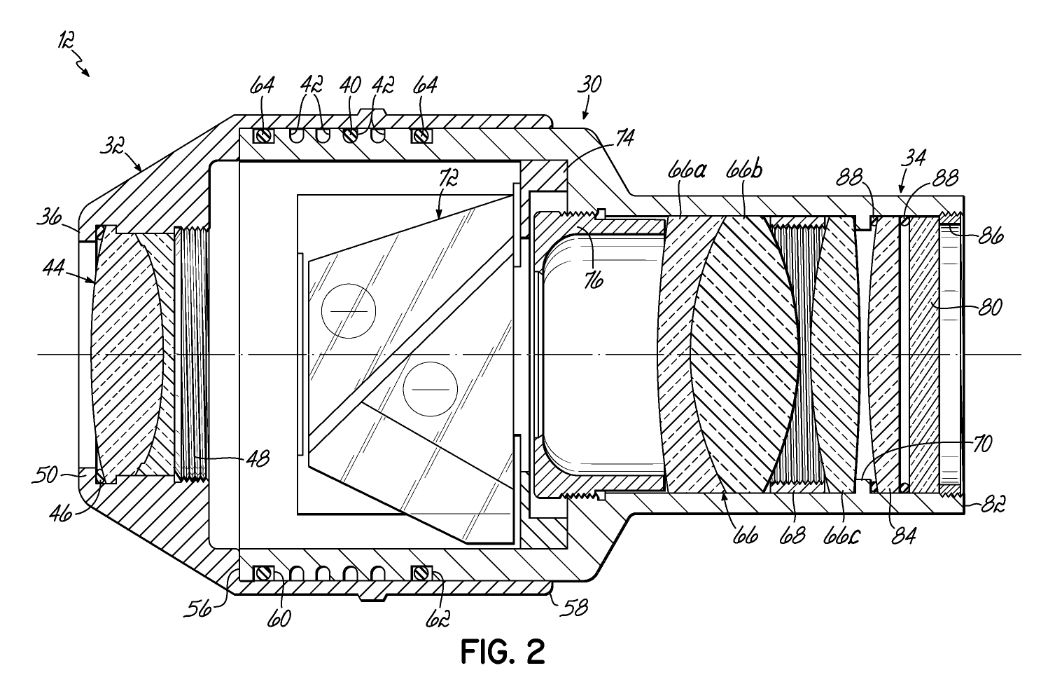

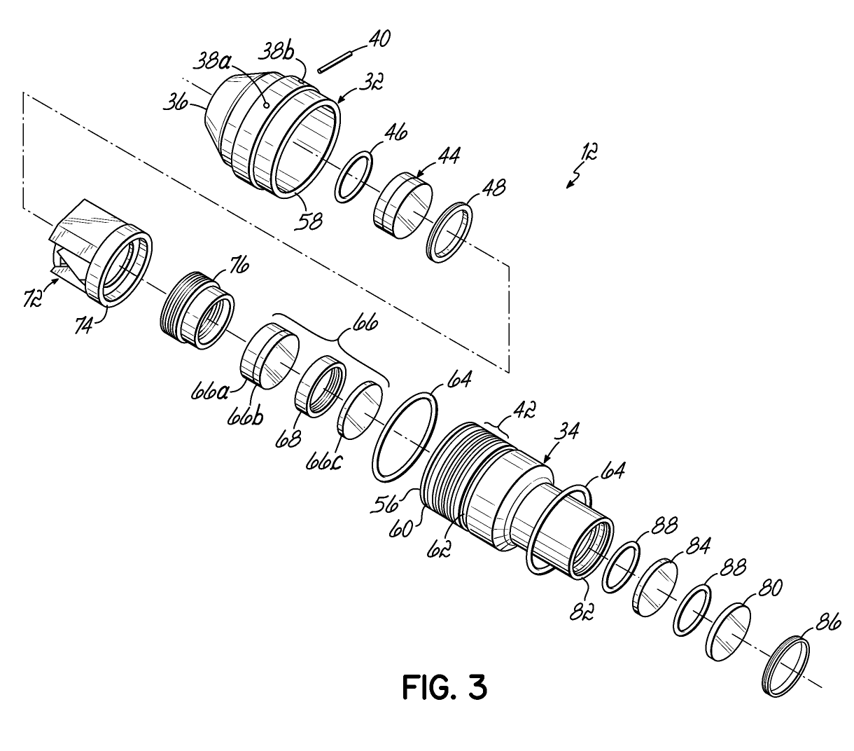

Referring now to FIGS. 2-3, the optical loupes 12 will be described in more detail. In the embodiment shown, optical loupe 12 is generally constructed in a manner similar to the optical loupes shown and described in U.S. Pat. No. 6,704,142 to Caplan et al., assigned to the assignee of the present invention and incorporated by reference herein in its entirety. The optical loupe 12 comprises a housing 30 for supporting the various components of the optical loupe 12 therein. In the embodiment shown, the housing 30 includes an objective lens portion 32 and an eyepiece lens portion 34. The objective lens portion 32 has a generally cylindrical shape with a tapered first end 36. A pair of apertures 38a, 38b through the outer circumference of the objective lens portion 32 are configured to receive a pin 40 therethrough to facilitate threadably securing the objective lens portion 32 of the housing 30 to the eyepiece lens portion 34. When the pin 40 is installed through the apertures 38a, 38b, the pin 40 defines a cord across the interior of the objective lens portion 32 so that the pin 40 can engage corresponding circular threads 42 formed in the outer surface of the eyepiece lens portion 34. The pin 40 may be selectively removed from the objective lens portion 32 to facilitate removal and replacement of the objective lens portion 32 with a different objective lens portion having a different objective lens, whereby the magnification power of the optical loupe 12 may be adjusted, as more fully described in U.S. Pat. No. 6,704,142

An objective lens 44 is supported in the objective lens portion 32 of the housing 30. An O-ring 46 and an objective lens retainer 48 that is threadably coupled to the first end 36 of the objective lens portion 32 secures the objective lens 44 against a lip 50 formed at first end 36 of the objective lens portion 32 of the housing 30. In the embodiment shown, the objective lens 44 is a two-element lens assembly, such as the objective lens described in U.S. Pat. No. 6,704,142. It will be appreciated, however, that the objective lens 44 may alternatively comprise various other configurations suitable for providing magnified viewing to a practitioner.

The eyepiece lens portion 34 of the housing 30 is also generally cylindrical in shape, and has a first end 56 with an outer diameter sized to be received within the second end 58 of the objective lens portion 32 for threadably coupling the objective lens portion 32 to the eyepiece lens portion 34, as discussed above. First and second O-ring grooves 60, 62 are formed on the first end 56 of the eyepiece lens portion 34 for receiving corresponding body O-rings 64 that seal the interface between the objective lens portion 32 and the eyepiece lens portion 34 of the housing 30. An eyepiece lens 66 is received within the interior of the eyepiece lens portion 34 of the housing 30 and, in this embodiment, comprises a three-element lens assembly selected to cooperate with the objective lens 44 to provide magnified viewing. In the embodiment shown, two elements 66a, 66b of the lens assembly are spaced apart from a third element 66c of the lens assembly by an eyepiece spacer 68. It will be appreciated, however, that the eyepiece lens 66 may alternatively comprise various other configurations suitable for providing magnified viewing to a practitioner. In the embodiment shown, the eyepiece lens 66 is supported within the eyepiece lens portion 34 of the housing 30 by a radially extending ridge 70, depicted in FIG. 2.

With continued reference to FIGS. 2-3, the optical loupe 12 may further include a prism assembly 72 received within the eyepiece lens portion 34 of the housing 30. The prism assembly 72 is supported within the housing on a prism base 74. A field stop 76 is disposed within the eyepiece lens portion 34 of the housing 30, between the prism assembly 72 and the eyepiece lens 66. In one embodiment, the objective lens 44, eyepiece lens 66, prism assembly 72, and field stop 76 may be constructed in accordance with the optical loupe shown and described in U.S. Pat. No. 6,704,142. It will be appreciated, however, that the optical loupe 12 may comprise various other configurations suitable for providing magnified viewing to a practitioner.

The optical loupe 12 further includes a filter lens 80 supported in the housing 30 to prevent the transmission of undesirable electromagnetic radiation, such as laser light, UV radiation, or any other potentially harmful radiation. For example, the filter lens 80 may be selected to provide protection from lasers in accordance with various standards, such as ANSI Z136.1, ANSI Z136.3, BS EN 207:1999, or various other standards. During use, the optical loupes 12 are positioned directly in front of the wearer's eyes to facilitate magnified viewing. As a result of this positioning and the fact that the loupes 12 are configured to magnify viewed objects, most of the laser light or other radiation directed toward a wearer's eyes must go through the loupes 12 themselves. Accordingly, positioning the filter lens 80 within the loupes 12 efficiently eliminates or reduces the amount of laser light or other radiation exposed to a wearer's eyes.

In one embodiment, the filter lens 80 may be selected to provide protection against laser light with wavelengths in the range of about 800 nm to about 830 nm at a power/pulse energy of up to about 10 Watts. In another embodiment, the filter lens 80 may be selected to provide protection against multi-wave laser light, such as laser light with wavelengths in the range of about 940 nm to about 980 nm, about 1064 nm, and about 2780 nm to about 2940 nm at a power/pulse energy of up to about 12 Watts. In yet another embodiment, the filter lens 80 may be selected to provide protection against laser light with wavelengths in the range of about 2780 nm to about 2940 nm at a power/pulse energy of up to about 12 Watts. It will be appreciated that the examples discussed herein are merely illustrative, and that the filter lens may alternatively be selected to protect against electromagnetic radiation having various other wavelengths or combinations of wavelengths.

In the embodiment shown, the filter lens 80 is supported in the eyepiece lens portion 34 of the housing 30, between the eyepiece lens 66 and the second end 82 of the eyepiece lens portion 34, but it will be appreciated that the filter lens 80 may alternatively be supported at various other locations within the housing 30. The optical loupe 12 may further include a prescription lens 84 supported within the eyepiece lens portion 34 of the housing 30 to provide vision corrected viewing of an image through the optical loupes 12. In the embodiment shown, the filter lens 80 and the prescription lens 84 are supported proximate the second end 82 of the eyepiece lens portion 34 of the housing 30 and are secured in position against the radially extending ridge 70 by an eyepiece retainer ring 86 that is threadably secured to the second end 82 of the eyepiece lens portion 34. O-rings 88 may be provided to space the prescription lens 84 and filter lens 80 within the eyepiece lens portion 34 of the housing 30.

While various aspects in accordance with the principles of the invention have been illustrated by the description of various embodiments, and while the embodiments have been described in considerable detail, they are not intended to restrict or in any way limit the scope of the invention to such detail. The various features shown and described herein may be used alone or in any combination. Additional advantages and modifications will readily appear to those skilled in the art. The invention in its broader aspects is therefore not limited to the specific details, representative apparatus and methods and illustrative examples shown and described. Accordingly, departures may be made from such details without departing from the scope of the general inventive concept.

What is claimed is:

1. An optical loupe, comprising:
a housing;
an eyepiece lens supported in said housing;
an objective lens supported in said housing and spaced from said eyepiece lens; and
a filter lens supported in said housing and adapted to prevent the transmission of electromagnetic radiation of at least a predetermined wavelength.

2. The optical loupe of claim 1, wherein said filter lens is adapted to prevent the transmission of laser light with wavelengths in the range of about 800 nm to about 830 nm at a power/pulse energy of up to about 10 Watts.

3. The optical loupe of claim 1, wherein said filter lens is adapted to prevent the transmission of multi-wave laser light with wavelengths in the range of about 940 nm to about 980 nm, about 1064 nm, and about 2780 nm to about 2940 nm at a power/pulse energy of up to about 12 Watts.

4. The optical loupe of claim 1, wherein said filter lens is adapted to prevent the transmission of laser light with wavelengths in the range of about 2780 nm to about 2940 nm at a power/pulse energy of up to about 12 Watts.

5. The optical loupe of claim 1, wherein said housing comprises an eyepiece lens portion and an objective lens portion, said eyepiece lens supported in said eyepiece lens portion and said objective lens supported in said objective lens portion.

6. The optical loupe of claim 5, wherein said objective lens portion is selectively adjustably coupled to said eyepiece lens portion, whereby a distance between said objective lens and said eyepiece lens may be adjusted by adjusting said objective lens portion relative to said eyepiece lens portion.

7. The optical loupe of claim 1, further comprising a prism in said housing and disposed between said eyepiece lens and said objective lens.

8. The optical loupe of claim 1 further comprising a vision correction lens supported in said housing.

9. A user wearable optical system, comprising:
a user wearable device; and
an optical loupe supported on said user wearable device, said optical loupe comprising:
a housing,
an eyepiece lens supported in said housing,
an objective lens supported in said housing and spaced from said eyepiece lens, and
a filter lens supported in said housing and adapted to prevent the transmission of electromagnetic radiation of at least a predetermined wavelength.

10. The user wearable optical device of claim 9, further comprising:
a shield coupled to said user wearable device and adapted to prevent the transmission of electromagnetic radiation of at least the predetermined wavelength.

11. The user wearable optical device of claim 9, wherein the user wearable device is a pair of eyeglasses.

12. The user wearable device of claim 11, wherein said optical loupe is supported by a carrier lens of said eyeglasses, said carrier lens adapted to prevent the transmission of electromagnetic radiation of at least the predetermined wavelength.

13. The user wearable device of claim 12, further comprising at least one shield coupled to said eyeglasses proximate said carrier lens, said shield adapted to prevent the transmission of electromagnetic radiation of at least the predetermined wavelength.
